(19) United States
(12) Patent Application Publication
(10) Pub. No.: US 2009/0120517 A1
(43) Pub. Date: May 14, 2009

(54) SELF REGULATING VALVE TO OBTAIN LOW DIFFERENTIAL AIR PRESSURE CONTROL

(76) Inventor: THOMAS JOSEPH WHITNEY, Tucson, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/938,683

(22) Filed: Nov. 12, 2007

(51) Int. Cl. F16K 31/00; F17D 3/00

(52) U.S. Cl. 137/624.27; 137/12

(57) ABSTRACT

A vehicle is provided with a controlled internal pressure to preclude intrusion of external atmospheric contaminants. The vehicle has an internally operable egress door. Internal pressure must be maintained low enough to allow occupants to readily open the egress door. A spring-biased poppet valve is used to maintain a requisite very low enclosure-to-atmosphere pressure differential (below 0.2 psid). The valve utilizes a diaphragm and a compression spring as force balancing elements. The compression spring has a spring constant of at least 0.5 pounds per inch.

### BACKGROUND OF THE INVENTION

The present invention is in the field of pressure control and, more particularly, air pressure control of environments in which people may be present.

In certain circumstances there is a need to maintain a small positive pressure within an enclosure i.e., a pressure greater than atmospheric pressure external to the enclosure. This need may arise in enclosures such as office buildings, manufacturing “clean rooms” or vehicle cabins. A need for accurate pressure control is particularly acute in vehicles that are exposed to widely varying external environmental conditions.

One example of such a pressure-control need may occur in a military vehicle that may be required to provide nuclear, biological and chemical (NBC) protection for its occupants. In such a vehicle, a positive interior pressure must be maintained at a level higher than external atmospheric pressure. But, the positive pressure must be maintained at a low differential relative to external atmospheric pressure. A pressure control requirement for such a vehicle may be as low as 0.1 pounds per square inch differential (psid) or about 2.8 inches of water. Furthermore ventilation must be provided in such a vehicle. In other words a specified amount of air must continuously flow into and out of the vehicle. Thus an NBC vehicle must be provided with a controlled throughput of air while its internal pressure is maintained at a low positive differential relative to atmospheric pressure.

The reason for such a low pressure differential requirement relates to structural aspects of the vehicle. In a vehicle with NBC protection, the doors of the vehicle are uniquely configured. A door for an NBC vehicle must be drawn inwardly before it can be opened outwardly. If pressure within the vehicle is too high, it may not be possible to draw the door inwardly for opening. It may be seen that a pressure as small as 0.1 psid will produce a force of about 86 pounds on a typical egress door, e.g., a door with a surface area of about six square feet. It is desirable to provide conditions in which no more than 150 pounds of force may be required to open the door. If interior pressures were allowed to rise to 1 psid then forces on the door would exceed 750 pounds.

In prior art NBC vehicles, a very low (e.g., 0.2 psid or less) positive pressure differential is controlled and maintained with sensors and numerous interconnected valve actuators and control valves. Complexity of these prior art systems may contribute to high expense and reduced reliability of NBC vehicles.

Various self-regulating pressure control valves exist in the prior art. Some of these prior art valves are expressly designed to control interior pressure of a vehicle such as aircraft cabin pressure. One example of such a prior art valve is a balanced poppet valve. Balanced poppet valves are used extensively in aircraft. But pressure setpoint requirements for aircraft are not as low as the requirements for an NBC vehicle. Typically, control of aircraft cabin pressure is considered adequate with setpoints down to about 0.9 psid. Prior art balanced poppet valves perform successfully at that level of pressure control.

Prior-art balanced poppet valves have provided simple and cost-effective pressure control in aircraft for decades. But, these prior art valves are not capable of providing required very low pressure control in NBC vehicles. Typically, these valves are constructed so that a desired pressure may be indirectly maintained through an ancillary metering valve. The metering valve operates with a control spring having a spring constant no lower than about 0.5 pounds per inch (lb/in) of compressive deflection. Control springs with spring constants lower than 0.5 lbs/in may not be suitable for use in poppet valves because they may not provide the accuracy required. Consequently a spring constant of 0.5 lbs/in is considered a lower limit for control springs used in poppet valves. This spring-constant lower limit translates into a lower limit of about 0.9 psid of pressure control capability for prior-art poppet valves with an ancillary metering valve.

As can be seen, there is a need to provide a simple pressure control system that may operate in a range of pressures below about 0.2 psid. Additionally, there is a need to provide a self-regulating valve that will control pressure at this low range.

### SUMMARY OF THE INVENTION

In one aspect of the present invention, an apparatus for maintaining a desired pressure of air flowing through an enclosure comprises a valve with an outlet in communication with an atmosphere outside of the enclosure and an inlet in communication with air inside the enclosure and a pressure-control member in the valve. The pressure-control member is directly displaceable responsively to an enclosure-to-atmospheric air pressure differential. The pressure-control member is spring biased to modulate air flow through the valve to maintain the enclosure-to-atmospheric air pressure differential within a predetermined range.

In another aspect of the present invention, a vehicle with a ventilated enclosure for transporting occupants in a hazardous atmospheric environment comprises a self-regulating spring-biased valve having a modulating pressure-control member. The valve has an outlet in communication with an atmosphere surrounding the vehicle. The pressure-control member is movable with force produced by an enclosure-to-atmosphere pressure differential.

In still another aspect of the present invention, a method for maintaining a desired air pressure within a ventilated enclosure comprises the steps of forcing air into the enclosure and releasing air from the enclosure through a self-regulating spring-biased valve by directly displacing a pressure-control member with force produced by an enclosure-to-atmosphere pressure differential.

These and other features, aspects and advantages of the present invention will become better understood with reference to the following drawings, description and claims.

### BRIEF DESCRIPTION OF THE DRAWINGS

FIG. 1 is block diagram view of an enclosure with a pressure control system in accordance with the invention;

FIG. 2 is a cross-sectional view of a pressure regulating valve in accordance with the invention; and

FIG. 3 is a flow chart of a method of controlling pressure in accordance with the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention may be useful for controlling air pressure in stationary or mobile enclosures, such as vehicles, clean rooms or buildings. More particularly, the present invention may provide for maintaining and controlling very low pressure in such enclosures. The present invention may be particularly useful in vehicles such as military vehicles.

In contrast to prior-art pressure control systems, among other things, the present invention may maintain a tightly controlled very low positive pressure in a cabin of a vehicle with a self-regulating pneumatic control valve. The present invention may, instead of employing complex combinations of prior-art electronic sensors, valve actuators and valves, utilize a balanced poppet valve to maintain pressure in a control range of about 0.2 psid or less.

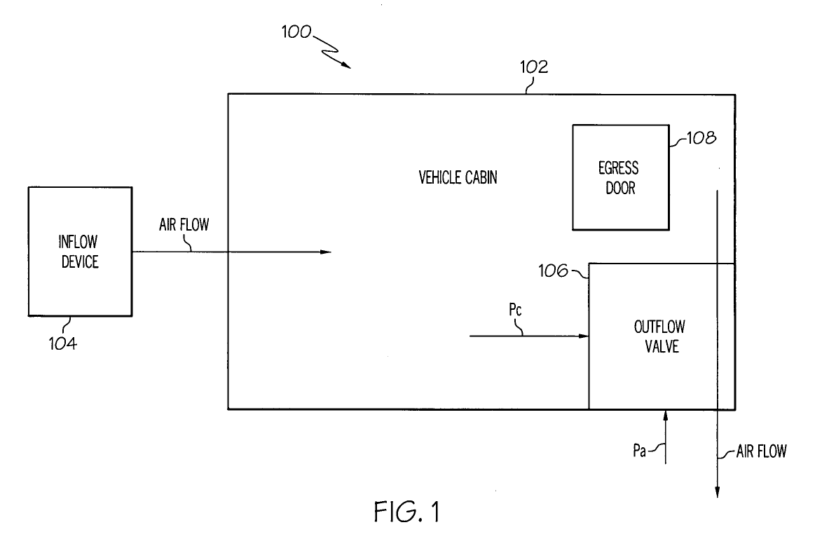

Referring now to FIG. 1, a block diagram portrays a typical NBC vehicle, designated generally by the numeral 100. The vehicle 100 may comprise a vehicle enclosure or cabin 102, an air inflow device 104 and an air outflow valve 106. The vehicle 100 may be an NBC vehicle with an inwardly operable egress door 108 that may be readily opened by occupants of the vehicle 100. The NBC vehicle 100 may be provided with a positive internal pressure to assure that external atmospheric contaminants do not enter the vehicle. However, the internal pressure may not be allowed to become great enough to interfere with operability of the egress door 108. These conditions may require maintenance of a very low positive pressure differential between cabin pressure Pc and external atmospheric pressure Pa. The required pressure differential may be as low as 0.2 psid or less.

In operation, the air inflow device 104 may draw filtered atmospheric air into the cabin 102 and thereby ventilate and pressurize the cabin or enclosure 102. The air inflow device 104 may comprise an air de-contamination system (not shown) and a pressurizing device such as a fan or compressor (not shown). The air inflow device 104 may operate continuously to deliver de-contaminated air into the cabin 102. A desired pressure Pc may be maintained in the cabin 102 because the air outflow valve 106 may permit air to escape from the cabin 102 whenever the desired pressure Pc is reached.

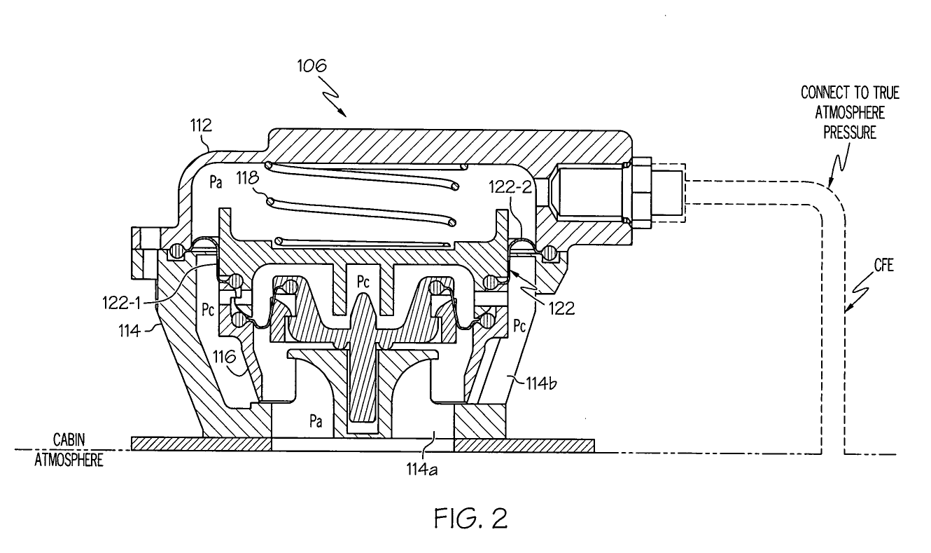

Referring now to FIG. 2, there is shown a balanced poppet valve which may perform the role of the air outflow valve 106 of FIG. 1. The balanced poppet valve of FIG. 2 is designated generally by the numeral 106. The valve 106 may comprise an upper body 112, a lower body 114, a pressure-control member or poppet 116, a spring 118 and a diaphragm 122.

In operation the valve 106 may be positioned within the vehicle 100 of FIG. 1 so that an outlet port 114a may be exposed to external atmospheric pressure Pc and inlet ports 114b may be exposed to internal cabin pressure Pc. When cabin air pressure exceeds external atmospheric pressure by a predetermined differential (Pc-Pa), the poppet 116 may move axially to allow air to escape from the cabin 102.

As air flows into the cabin 102 of FIG. 1 the pressure differential (Pc-Pa) may increase. The poppet 116 may move axially to allow some of the cabin air to escape to the atmosphere. As an amount of inflowing air increases, the pressure differential (Pc-Pa) may increase. In that case the poppet 116 may increase its axial movement. Such an increase in axial movement of the poppet 116 may result in increased air flow into the inlet ports 114b and out through the outlet port 114a. A balanced flow may develop through the cabin 102 as the valve 106 releases air from the cabin 102 at a sufficient rate to maintain a desired enclosure-to atmosphere pressure differential within the cabin 102. A pressure differential of about 0.1 psid to about 0.2 psid may be maintained. The valve 106 may directly control the pressure differential without use of an ancillary metering valve.

It may be noted that the diaphragm and attached (hereinafter called diaphragm) 122 may comprise a rigid poppet plate 122-1 and a flexible annular member 122-2 in communication with the cabin 102 on one side and the atmosphere on the other side. The diaphragm 122 may be attached to the poppet 116. In a presence of a positive (Pc-Pa), the diaphragm 112 may produce an axial displacing force on the poppet 116. In the inventive valve 106, the diaphragm 122 may be large enough to produce a significant axial force on the spring 118. Axial force produced by the diaphragm 122 may be counteracted by axial forces produced by the spring 118. This arrangement may uniquely allow for control of very low pressures while employing a spring with that performs with proper repeatability.

This may be better understood by considering an exemplary dimensional relationship of various elements of the valve 106. In a typical one of the vehicle cabins 102, a limited volume of space may be available for the valve 106. As an example, a space envelope for the valve 106 may be specified at a size of about 6 inches in diameter and about 2 inches deep or about 60 cubic inches. Thus, an exemplary one of the valves 106 may have a maximum diameter and depth that fits into the specified space envelope. Within that limited space envelope, the valve 106 may be required to have air passages large enough to release air from the cabin 102 at a specified rate and at a specified low (Pc-Pa).

In order for the spring 118 to have a spring constant of at least about 0.5 lbs/in the poppet 116 may require displacement against a spring force of at least two pounds. Displacement of the poppet 116 may be provided with force developed by the diaphragm 122. At a low pressure of about 0.1 psid, a two pound displacement force may require that the diaphragm have a surface area of about twenty square inches. If the diaphragm 122 were any smaller, the poppet 116 may not be held in a balanced position with a spring having a spring constant of 0.5 lbs/in. In other words, if the diaphragm 122 were smaller, the spring 118 might need to be constructed with a spring constant less than 0.5 lbs/in. As described hereinbefore, a spring constant of 0.5 lbs/in may be a lower limit for poppet valve compression springs. Compression springs with spring constants lower than 0.5 lb/in may not provide reliable and repeatable deflection performance.

The inventive valve 105 may be constructed so that the surface area of the diaphragm 122 is large enough to produce a counteracting force on the spring 118 which force is large enough to permit construction of the spring 118 with a spring constant of at least about. 0.5 lbs/in. This may be accomplished by allowing the cabin pressure to create a force on one side of the diaphragm 122 which opposes a combined atmospheric pressure and spring force on the other side of the diaphragm 122. When such a configuration is provided, the surface area of the diaphragm 122 may be made relatively large while permitting a presence of a relatively large poppet 116 in the valve 106 in spite of the valve 106 having limited size. In the exemplary valve 106 discussed hereinabove, the valve body 114 may have an exterior diameter of about 6 inches. The diaphragm 122 may have a surface area of about 20 square inches and the poppet 116 may have a diameter of about 5 inches. Thus the poppet 116 may have a diameter that is more than 80% of the diameter of the valve body 114. Such an arrangement, with a relatively large poppet 116 provides an opportunity for air flow of up to about 240 cubic feet per minute through the valve 106 at a pressure of about 0.1 psid.

Consequently, one of the NBC vehicles 100 may be provided with a generous volume of ventilation air for its occupants even though the valve 106 may occupy a space envelope no larger than about 60 cubic inches in the vehicle 100. Furthermore, the inventive valve 106 may control a requisite internal pressure in the vehicle 100 without any sensing devices or control elements that may be external to the valve 106 itself.

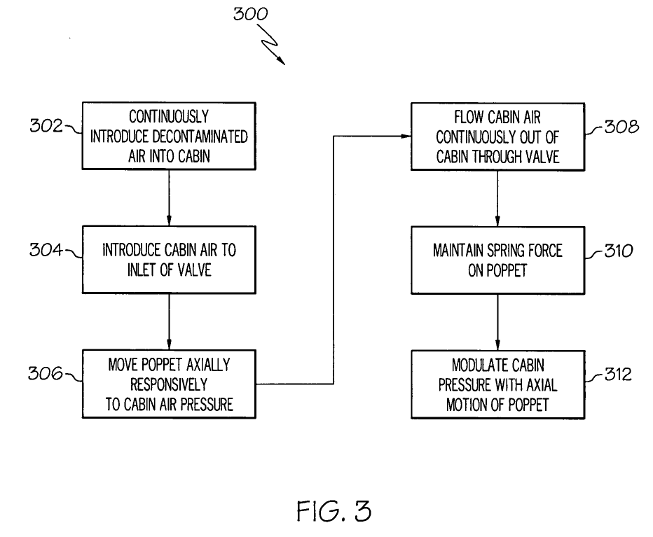

In one embodiment of the present invention, a method may be provided for maintaining a desired air pressure within a ventilated enclosure (e.g. the vehicle cabin 100). In that regard the method may be understood by referring to FIG. 3. In FIG. 3, a flow chart portrays various aspects of an inventive method 300. In a step 302, air may be continuously introduced into the enclosure (e.g. by the inflow device 104). In a step 304, air may be introduced into an inlet of a valve (e.g. the inlet 114b of the valve 106). In a step 306, a pressure-control member (e.g., the poppet 116) may move responsively to an enclosure-to atmosphere pressure differential (e.g., movement of the poppet 116 is responsive to [Pc-Pa]). In a step 310, a spring force may be maintained on the pressure-control member to limit its movement (e.g. the spring 118 may produce force against the poppet 116). In a step 312, enclosure-to-atmospheric pressure differential may be maintained with modulating axial movement of the pressure-control member.

It should be understood, of course, that the foregoing relates to exemplary embodiments of the invention and that modifications may be made without departing from the spirit and scope of the invention as set forth in the following claims.

We claim:

1. An apparatus for maintaining a desired pressure of air flowing through an enclosure comprising:
a valve with an outlet in communication with an atmosphere outside of the enclosure and an inlet in communication with air inside the enclosure;
a pressure-control member in the valve;
the pressure-control member being directly displaceable responsively to an enclosure-to-atmospheric air pressure differential; and
the pressure-control member being spring biased to modulate air flow through the valve to maintain the enclosure-to-atmospheric air pressure differential within a predetermined range.

2. The apparatus of claim 1 wherein the pressure-control member comprises an axially displaceable poppet biased with a compression spring.

3. The apparatus of claim 1 further comprising:
a diaphragm attached to the pressure-control member and enclosing a first end of the chamber; and
the diaphragm being in communication with the enclosure so that air pressure within the enclosure acts on the diaphragm to produce an axial force on the poppet in a direction opposite to a spring-bias force on the pressure-control member.

4. The apparatus of claim 1 wherein:
spring bias of the pressure-control member is produced with a compression spring having a spring constant of at least 0.5 pounds per inch of displacement (lb/in); and
the enclosure-to-atmospheric pressure differential is less than 0.2 pounds per square inch differential (psid).

5. A vehicle with a ventilated enclosure for transporting occupants in a hazardous atmospheric environment comprising:
a self-regulating spring-biased valve having a modulating pressure-control member;
the valve having an outlet in communication with an atmosphere surrounding the vehicle; and
the pressure-control member being movable with force produced by an enclosure-to-atmosphere pressure differential.

6. The vehicle of claim 5 wherein:
the enclosure has an inwardly operable door for egress of the occupants; and
the desired enclosure-to-atmosphere pressure differential is positive but low enough to permit door opening by the occupants.

7. The vehicle of claim 6 wherein the door has a surface area of at least six square feet.

8. The vehicle of claim 6 wherein force applied to the door by the enclosure-to-atmosphere pressure differential is no greater than 150 pounds.

9. The vehicle of claim 5 wherein the pressure-control member is biased with a compression spring.

10. The vehicle of claim 9 wherein the compression spring has a spring constant no less than 0.5 pounds per inch of deflection.

11. The vehicle of claim 5 wherein the enclosure-to-atmosphere pressure differential is maintained within a range of 0.1 psid to 0.2 psid.

12. The vehicle of claim 11 further comprising an air inflow device.

13. The vehicle of claim 12 wherein airflow through the vehicle is at least 240 cubic feet per minute.

14. The vehicle of claim 13 wherein the valve fits in a space envelope no greater than 60 cubic inches.

15. The vehicle of claim 5 wherein the enclosure-to-atmosphere pressure differential is maintained by pneumatic control without use of any sensing or control devices external to the valve.

16. A method for maintaining a desired air pressure within a ventilated enclosure comprising the steps of:
forcing air into the enclosure; and
releasing air from the enclosure through a self-regulating spring-biased valve by directly displacing a pressure-control member with force produced by an enclosure-to-atmosphere pressure differential.

17. The method of claim 16 wherein:
the air if forced into a vehicle having an inwardly operable door for egress of occupants; and
the desired enclosure-to-atmosphere pressure differential is maintained low enough to permit door opening by the occupants.

18. The method of claim 16 wherein the steps of forcing air and releasing air produce airflow of at least 240 cubic feet per minute.

19. The method of claim 16 further comprising producing a counteracting force, in opposition to the displacing force, with a compression spring.

20. The method of claim 16 wherein the desired pressure is maintained by maintaining the enclosure-to atmosphere pressure differential in a range of 0.1 psid to 0.2 psid.
